(19) United States
(12) Patent Application Publication
(10) Pub. No.: US 2008/0191117 A1
(43) Pub. Date: Aug. 14, 2008

(54) Suspension for an Oscillating Load, Especially for an Exhuast System of a Motor Vehicle

(75) Inventors: Klaus Steinmaier, Waldkraiburg (DE); Markus Schilder, Schnaitsee (DE)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: SGF Suddeutsche Gelenkscheiben fabrik Gmbh & Co., KG a corporation

(21) Appl. No.: 11/909,274

(22) PCT Filed: Mar. 9, 2006
(86) PCT No.: PCT/EP2006/002187

§ 371 Date: Oct. 2, 2007

(30) Foreign Application Priority Data
Apr. 6, 2005 (DE) 10 2005 015 796.3

(51) Int. Cl. F16M 13/00

(52) U.S. Cl. 248/610

(57) ABSTRACT

The present invention relates to a suspension for an oscillating load, in particular for an exhaust system of a motor vehicle, with an elastomer body (26; 36; 38) which comprises at least one fixing hole (28) which is lined with a reinforcement, and with a suspension bolt (20) which is passed through the fixing hole (28). In order to increase the wear resistance and to facilitate assembly, the reinforcement is a shell (30) which lines the fixing hole (28) predominantly on the side of its cross section which is mainly loaded by the suspension bolt (20), and the suspension bolt (20) has a thickened head (24) protruding from the fixing hole (28).

The invention relates to a suspension for an oscillating load, in particular for an exhaust system of a motor vehicle, with an elastomer body which comprises at least one fixing hole which is lined with a reinforcement, and with a suspension bolt which is passed through the fixing hole.

A suspension of this kind is known, for example, from DE 37 37 987 C. Here two diametrically opposite fixing holes, which are lined with a respective cylindrical bush, are formed in a diamond-shaped elastomer body. A pack of loops, which is embedded in the elastomer body, extends around the two bushes.

Further suspensions of the above-mentioned kind are known from DE 198 25 810 C as well as DE 198 25 811 C and DE 100 13 121. According to DE 198 25 810, the bushes with which the fixing holes are lined can consist of steel or of a heat-insulating hard material, or can be omitted, so that the suspension bolts are inserted directly in the fixing holes. The latter represents a return to prior suspensions, for example according to DE 26 58 358 B or DE 30 34 370 C, in which suspension hooks of a circular arc-shaped cross section which are stamped out of sheet metal engage directly in corresponding fixing holes of an elastomer body.

Suspensions of the kind discussed here are generally stressed not only by the weight—the effect of which may be increased by dynamic influences—of the suspended load, but also due to the fact that the load, for example the exhaust system of a motor vehicle, executes oscillating movements in consequence of mass inertial forces and/or of thermal expansions. It has been considered desirable, in particular on account of movements of this kind, to line the fixing holes in the elastomer body with bushes. However this has the disadvantage that the suspension bolts, as is obvious from DE 37 37 987 C, for example, can only secure the elastomer body against unintentional axial displacement on one side through a collar which is formed in one piece with these bolts; in order to secure it against displacement in the opposite direction, it is necessary to provide a securing element, for example in the form of a spring lock washer locked into a groove in the end region of the suspension bolt, on the end of the suspension bolt which is passed through the associated bush.

In order to enable suspensions according to the preamble to be quickly assembled, it has in the meantime become usual to lock the elastomer body onto suspension bolts with a mushroom-shaped head. This is only possible if the fixing holes can be temporarily widened, i.e. are not lined with bushes.

The object of the invention is to develop a suspension of the type initially described such that it combines the advantages of high wear resistance, even in the case of significant oscillating movements of the suspended load, on the one hand and the possibility of easy assembly on the other.

The object is achieved according to the invention in that

the reinforcement is a shell which lines the fixing hole predominantly on the side of its cross section which is mainly loaded by the suspension bolt, and

the suspension bolt has a thickened head protruding from the fixing hole.

The shell according to the invention is preferably at most semicircular in cross section; it is generally sufficient for the shell to have a cross section which corresponds to a quarter or even just a sixth of a circle.

It is also of advantage for the shell to comprise structures, for example holes or flutes, for anchoring it in the elastomer body.

Irrespective of the way in which it is anchored in the elastomer body, it is expedient for the shell to comprise external longitudinal ribs on which at least one pack of loops lies, this being fixed by material of the elastomer body having penetrated into interspaces between the longitudinal ribs.

According to one development, the shell comprises flanges for the lateral support at least of one pack of loops.

It is also expedient for the shell to be coated with an adhesion promoter on its surfaces which contact the elastomer body.

When producing the elastomer body by injection moulding or vulcanising, it is necessary to temporarily fix the or each shell in the mould used for this purpose such that it is moulded around or vulcanised in at the correct location. For this purpose at least one clamp is preferably formed on the shell, with which clamp the shell can be fixed to a bolt inside the mould.

The clamp may be formed by fingers which protrude from mutually opposite longitudinal edges of the shell.

A clamp is expediently formed at each end of the shell.

As in the case of known suspensions according to the preamble, the elastomer body is preferably made of rubber or rubber-like plastics material. Depending on the type of material which is used for the elastomer body, the shells according to the invention are either vulcanised in, embedded when injection moulding the elastomer body from plastics material or subsequently glued into the finished elastomer body.

The invention is illustrated in detail in the following on the basis of embodiments which are represented graphically. In the drawings

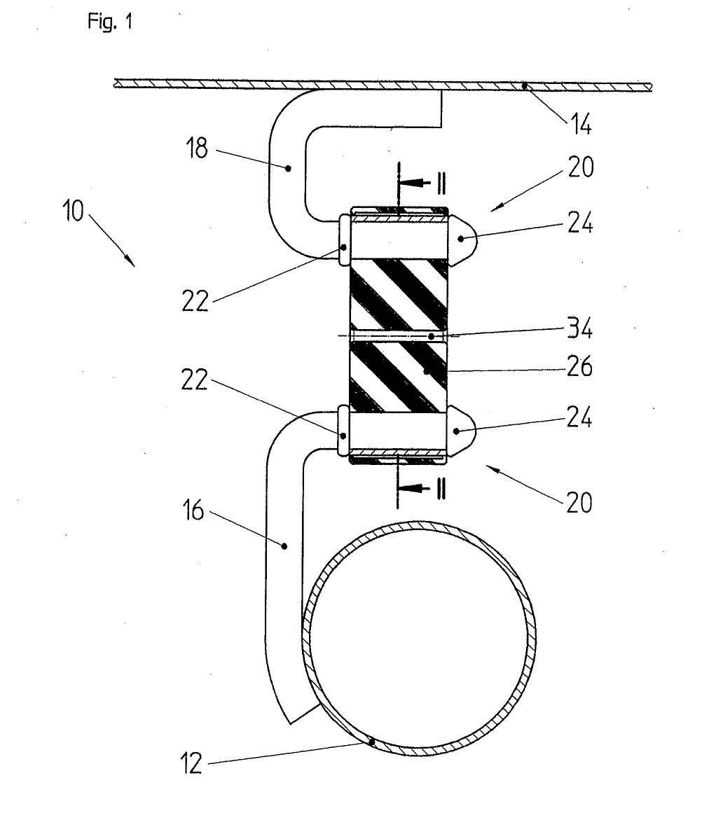

FIG. 1 is a perpendicular section through a first embodiment of a suspension for an exhaust system of a motor vehicle;

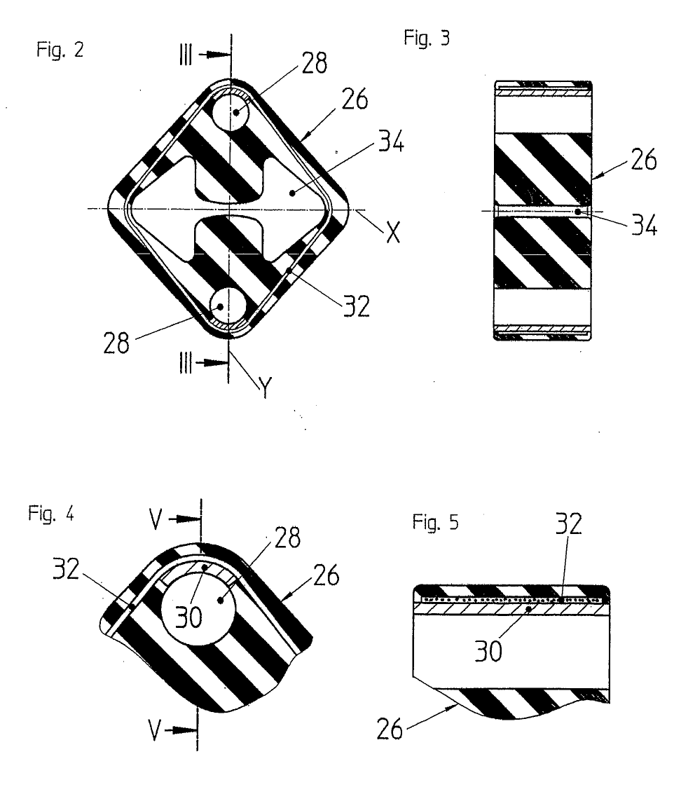

FIG. 2 is the section II-II in FIG. 1;

FIG. 3 is the section III-III in FIG. 2;

FIG. 4 is an enlarged detail from FIG. 2;

FIG. 5 is the section V-V in FIG. 4;

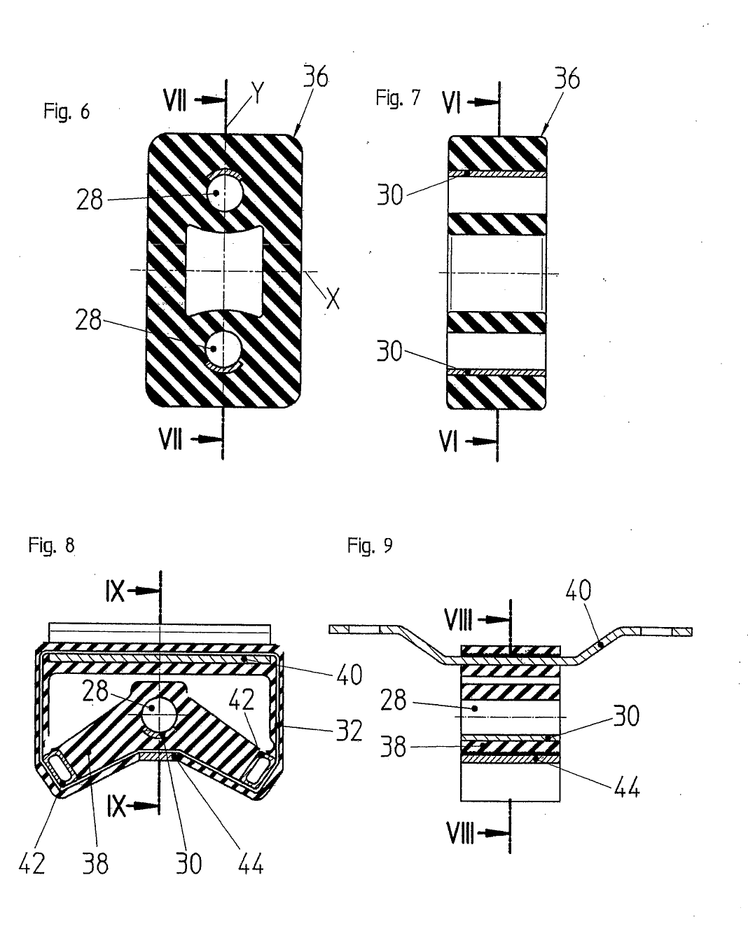

FIG. 6 is an embodiment modified with respect to FIG. 2 in the section VI-VI in FIG. 7;

FIG. 7 is the section VII-VII in FIG. 6;

FIG. 8 is a further embodiment in the section VIII-VIII in FIG. 9;

FIG. 9 is the section IX-IX in FIG. 8;

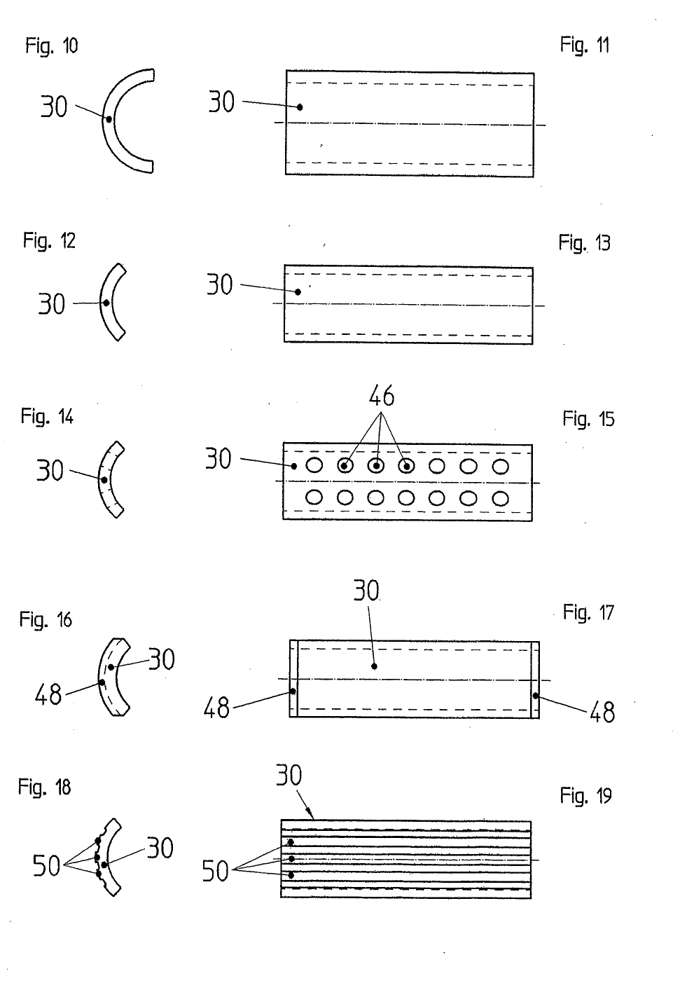

FIG. 10 is a first embodiment of a shell in a front view;

FIG. 11 is the plan view associated with FIG. 10;

FIG. 12 is a modified shell in a front view;

FIG. 13 is the plan view associated with FIG. 12;

FIG. 14 is a shell which has been further modified;

FIG. 15 is the plan view associated with FIG. 14;

FIG. 16 is a shell which has again been modified in a front view;

FIG. 17 is the plan view associated with FIG. 16;

FIG. 18 is a shell which has once more been modified in a front view;

FIG. 19 is the plan view associated with FIG. 18;

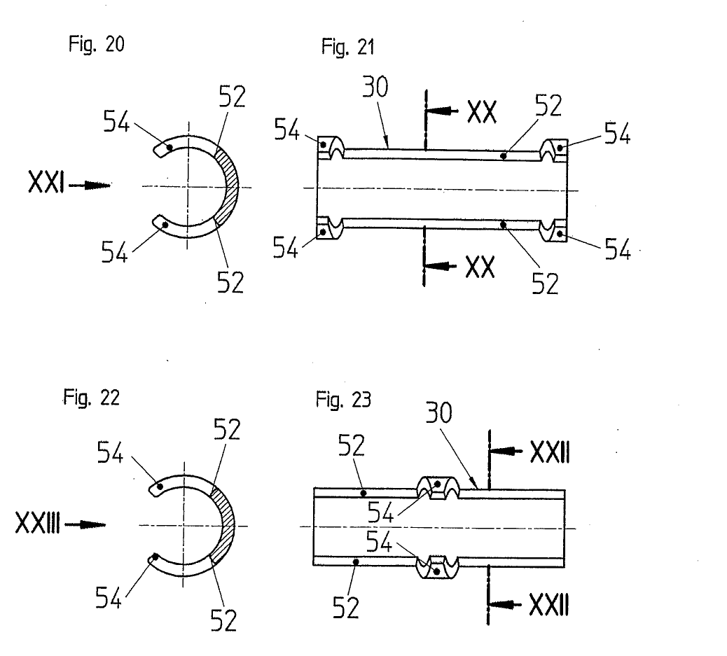

FIG. 20 is a shell which has been further modified in the section XX-XX in FIG. 21;

FIG. 21 is the view in the direction of the arrow XXI in FIG. 20;

FIG. 22 is a variant of FIG. 20, marked as section XXII-XXII in FIG. 23;

FIG. 23 is the view in the direction of the arrow XXIII in FIG. 22.

A suspension 10, with which a pipe 12 of the exhaust system of a motor vehicle is suspended from the floor 14 of the motor vehicle, is represented in FIG. 1. A lower steel clip 16, which-is welded to the pipe 12, as well as an upper steel clip 18, which is welded to the floor 14, form part of the suspension 10. A respective circular cylindrical suspension bolt 20 is formed in one piece on the two steel clips 16 and 18, which bolt begins with a collar 22 and ends with a mushroom-shaped head 24. The two steel clips 16 and 18 are connected together by an elastomer body 26 which, in the view according to FIG. 2, has a contour which is similar to a square standing on a vertex, yet is rounded, and comprises a respective fixing hole 28 near its lower and its upper corner. The lower fixing hole 28 is lined in its lower region and the upper fixing hole 28 in its upper region with a quarter-cylindrical shell 30. In the represented example the two shells 30 consist of metal; however they may also consist of a plastics material which—if necessary by means of an adhesion promoter—adheres firmly to the elastomer body 26, although on the other hand forms a low-friction sliding pair with the associated suspension bolt 20. A pack of loops 32, which is embedded in the elastomer body 26 and formed from numerous windings of a tension-proof thread or wire, extends around the two shells 30.

The elastomer body 26 together with the two shells 30 embedded therein and the pack of loops 32 forms a prefabricated, for example vulcanised unit, before the suspension 10 is assembled as can be seen from FIG. 1. Assembly takes place by locking the elastomer body 26 onto the two suspension bolts 20. In the process the fixing holes 28, the diameter of which is closely adapted to that of the suspension bolts 20, is temporarily widened by the associated mushroom-shaped head 24 in order then to assume its circular cross-sectional shape again as soon as the head 24 of the associated suspension bolt 20 has been pushed completely through the fixing hole 28 in question, as represented in FIG. 1. The elastomer body 26 then lies with one of its two front faces, with the left one in FIG. 1, against the two collars 22, and with the opposite front side against the base of the two heads 24. The two shells 30 are dimensioned in terms of their length so that they fit with a slight axial clearance in the interspace between the collar 22 and the head 24 of the associated suspension bolt 20.

The elastomer body 26 is symmetrical in relation to a centre plane X, which is horizontal in FIG. 2, as well as in relation to a perpendicular centre plane Y, which contains the axes of the two fixing holes 28, and comprises a central cut-out 34 which, according to FIG. 2, is in the shape of a double arrow.

FIGS. 6 and 7 depict an elastomer body 36 which is modified with respect to the elastomer body 26 represented in FIGS. 1 to 5 and the outer contour of which is rectangular in both views or sections. This elastomer body 36 is dimensioned so that it is capable by itself of transmitting all forces occurring during operation; a reinforcement corresponding to the pack of loops 32 represented in FIGS. 1 to 5 is not provided here. However the two fixing holes 28 are also reinforced with a partly cylindrical shell 30 in the case of the elastomer body 36 which is represented in FIGS. 6 and 7.

An elastomer body 38, which comprises just one fixing hole 28, is represented in FIGS. 8 and 9 for the sake of completeness. This hole corresponds to the fixing hole 28 which is the lower one in the preceding embodiments and, like this, is reinforced at its underside with a partly cylindrical shell 30. The elastomer body 38 in FIGS. 8 and 9 comprises a suspension plate 40, which is embedded therein, instead of an upper fixing hole. Lateral stiffening elements 42 and a central stiffening element 44 are in addition embedded in the elastomer body 38.

It can be seen from FIGS. 10 and 11 on the one hand as well as FIGS. 12 and 13 on the other that the cross-sectional shape of the shells 30 can be varied within certain limits according to the occurring loads and also according to the material which is selected for the shells. However the cross section should not be substantially more than semicircular and not substantially less than quadrantal.

The shell 30 which is represented in FIGS. 14 and 15 is provided with structures 46 for anchoring it in the elastomer body 26 or 36 or 38. As depicted, these structures 46 may be circular holes, for example.

The shell 30 which is depicted in FIGS. 16 and 17 has at its two ends a respective flange 48 which protrudes radially outwards and is intended for securing the pack of loops 32 against lateral displacement.

The shell 30 which is depicted in FIGS. 18 and 19 is provided on its outside with longitudinal ribs 50 whose outer circumferential surfaces serve as bearing surfaces for the pack of loops 32, while the longitudinal groves which are formed between the longitudinal ribs 50 are provided to accommodate material of the elastomer body 26 or 36 or 38 and thereby to ensure that the pack of loops 32 is firmly embedded.

The shell 30 which is depicted in FIGS. 20 and 21 has at both of its ends a respective pair of clamp fingers 54 which protrude from its longitudinal edges 52 in the circumferential direction. Each pair of these clamp fingers forms a clamp 54, 54 with which the shell 30 can be fixed to a cylindrical bolt inside a mould for injection moulding or vulcanising the associated elastomer body 26 or 36.

The shell according to FIGS. 22 and 23 differs from that which is depicted in FIGS. 20 and 21 in that it only comprises a single pair of clamp fingers 54, and that this is disposed in the central region of the shell.

1. Suspension for an oscillating load, in particular for an exhaust system of a motor vehicle, with an elastomer body (26; 36; 38) which comprises at least one fixing hole (28) which is lined with a reinforcement, and with a suspension bolt (20) which is passed through the fixing hole (28),
characterised in that
the reinforcement is a shell (30) which lines the fixing hole (28) predominantly on the side of its cross section which is mainly loaded by the suspension bolt (20), and
the suspension bolt (20) has a thickened head (24) protruding from the fixing hole (28).

2. Suspension according to claim 1,
characterised in that the shell (30) is at most semicircular in cross section.

3. Suspension according to claim 1,
characterised in that the shell (30) comprises structures (46) for anchoring it in the elastomer body (26; 36; 38).

4. Suspension according to claim 1,
characterised in that the shell (30) comprises external longitudinal ribs (50) on which at least one pack of loops (32) lies, wherein this is fixed by material of the elastomer body (26; 36; 38) having penetrated into interspaces between the longitudinal ribs.

5. Suspension according to claim 1,
characterised in that the shell (30) comprises flanges (48) for the lateral support at least of one pack of loops (32).

6. Suspension according to claim 1,
characterised in that the shell (30) is coated with an adhesion promoter on its surfaces which contact the elastomer body (26; 36; 38).

7. Suspension according to claim 1,
characterised in that at least one clamp (54, 54) is formed on the shell (30), with which clamp the shell (30) can be fixed to a bolt inside a mould for moulding the elastomer body (26; 36; 38).

8. Suspension according to claim 7,
characterised in that the clamp (54, 54) is formed by fingers which protrude from mutually opposite longitudinal edges (52) of the shell (30).

9. Suspension according to claim 8,
characterised in that a clamp (54, 54) is formed at each end of the shell (30).
